(19) United States
(12) Patent Application Publication
(10) Pub. No.: US 2009/0252976 A1
(43) Pub. Date: Oct. 8, 2009

(54) COVER MEMBER FOR PUSH BUTTON SWITCH AND PROCESS FOR PRODUCING THE SAME

(76) Inventor: Shunta Hyuga, Tokyo (JP)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 12/295,028

(22) PCT Filed: Apr. 10, 2007
(86) PCT No.: PCT/JP2007/057885

§ 371 Date: Mar. 24, 2009

(30) Foreign Application Priority Data
Apr. 18, 2006 (JP) 2006-114030

(51) Int. Cl. B32B 27/08; B32B 37/12

(52) U.S. Cl. 428/447; 156/275.5

(57) ABSTRACT

A cover member for a push bottom switch having excellent adhesiveness, durabilities for long-term usage, and humidity resistance and manufacturing the same. The cover member for push button switch comprises a resin key top, a silicone rubber key sheet integrated with the resin key top, and an adhesive layer that bonds the silicone rubber key sheet with the resin key top and includes an optical curing resin, an amine silane compound and a hydrophobic silane compound. In the cover member for push button switch, the area of the adhesive layer becomes one third or more of the adhesive layer areas of the resin key top and the silicone rubber key sheet.

### FIELD OF THE INVENTION

The present invention relates to a cover member for a push button switch favorably used as a component of a push button switch and a method of manufacturing the same.

### BACKGROUND OF THE INVENTION

In recent years, push button switches comprising a resin key top and a rubber-like elastic key sheet are widely used as cover members for a push button switches used for mobile devices such as mobile phones, personal digital assistants or the like. In particular, a silicone rubber is appropriate for a key sheet member because of its superior heat resistance, moisture resistance, insulating performance, and accurate molding. On the other hand, it is strongly required as a molded cover member for a push button switch that a resin key top is stably bonded with a rubber-like elastic key sheet.

A cover member for a push button switch used as a component of a push button switch is conventionally manufactured by the following method, for example. First, the surface of a rubber-like elastic key sheet to be bonded with a resin key top is irradiated by ultraviolet light and cleaned. Next, a primer is applied on the surface of at least one of the rubber-like elastic key sheet and the resin key top. Next an ultraviolet curable adhesive is transferred to the above bonded surface so as to form an adhesive layer. Finally, the resin key top is bonded with the rubber-like elastic key sheet and the adhesive layer is cured by the irradiation of ultraviolet light so as to form the cover member for a push button switch (see the patent document 1.)

Alternatively, the following method is adopted to manufacture such cover member. After the bonded surfaces of the resin key top and the rubber-like elastic key sheet is modified, a photo-curing resin as an adhesive including an individual silane compound is coated over the bonded surface. Next the resin key top is attached to the rubber-like elastic key sheet and bonded by irradiating light. This method is also well known (for an example, refer to the patent document 2)

[Patent document 1] Japanese Patent publication 11-086667A (Claims)
[Patent document 2] Japanese Patent publication 2000-243175A (Claims)

The above conventional cover member for a push bottom switch, however, has the following problems. In case of the cover member for a push button switch disclosed in the patent document 1, adhesion can be accomplished in a very short time, and the increase of tactile feeling is recognized. But, it is difficult to attain satisfactory adhesive strength since the resin key top is bonded with the rubber-like elastic key sheet by curing the ultraviolet curable adhesive. As a result, the adhesive durability under high temperature—high humidity environment or the long-term usage is not enough. Especially when adopting a silicone rubber for the rubber-like elastic key sheet, a primer treatment is required since it lacks adhesiveness. Therefore, the manufacturing process becomes more complex, resulting in the problem that it leads to an increase in manufacturing costs

In case of the cover member of the push button switch disclosed in the patent document 2, it shows higher adhesiveness and moisture resistance. Furthermore, without adopting the primer treatment to a silicone rubber, it is possible to achieve the cover member of the push button switch with relatively high adhesiveness. This property of the cover member can be attained because a photo-curable resin including an individual silane compound is adopted as an adhesive during the manufacturing process, and as a result of hydrolysis reaction, silanol hydroxyl based on an alkoxyl group of the silane compound bonds with silanol hydroxyl of the modified silicone rubber.

However, in the high temperature—high humidity environment, a hydroxyl bond between a silane compound and a silicone rubber becomes weak when water enters the bonded interface. Also, due to transfer process of the adhesive in the air, the adhesive exposed to the air is reacted with water in the air as hydrolysis/siloxane binding reaction, resulting in that the active hydroxyl group of silanol, which can bind with the silicone rubber, is decreased. As a result, the adhesion stability of the cover member of the push button switch lowers, and the cover member for the push button switch is not suitable under the high temperature—high humidity environment.

In order to solve the above problems, the present invention is to provide the cover member for the push button switch that shows high durability against an extended usage, superior adhesiveness and humidity resistance and a method of manufacturing the same.

### OBJECTS AND SUMMARY OF THE INVENTION

In order to achieve the aforementioned object, the present invention is, a cover member for a push bottom switch comprises; a resin key top; a silicone rubber key sheet integrated with the resin key top; and adhesive layer that bonds the silicone rubber key sheet with the resin key top and includes an optical-curable resin, an amine silane compound and a hydrophobic silane compound. The area of the adhesive layer is one third or more of the area in which the silicone rubber key sheet is bonded with the resin key top.

Adopting the push button switch structured above, it keeps superior adhesiveness. While the silane compound is able to maintain the adhesiveness with a resin due to its belonging to an organic-functional group, it is able to form a stable chemical bond with a hydroxyl on the surface of the modified silicone rubber key sheet. The hydroxyl is generated by hydrolyzing a hydrolyzable group. As a result, the adhesiveness of the cover member of the push button switch can be further increased. Furthermore, mixing the hydrophobic silane compound into the adhesive prevents water from entering into the bonded surface. The adhesiveness of the cover member of the push button switch significantly depends on the area of the adhesive layer between the resin key top and the silicone rubber key sheet. Further, since the area of the adhesive layer between the resin key top and the silicone rubber key sheet is made to be the one third of the bonded surface area, resin key top and the silicone rubber key sheet can be bonded tighter. Also, when structuring the push button switch including a luminescence member located on the lower part of the silicone rubber key sheet, light emitted from the luminescent member more uniformly transmits the cover member of a push button switch since the adhesive layer's width is adequate.

For the hydrophobic silane compound, an epoxy silane compound, a fluorinated silane compound, a methacryloyloxy silane compound, a phenyl silane compound and an acrylic silane compound are exemplarily illustrated. The epoxy silane compound includes 2-(3,4 epoxycyclohexyl)ethyl trimethoxysilane, 3-glycidoxypropyltrimethoxysilane, 3-glycidoxypropyltriethoxysilane and 3-glycidoxypropylmethyldiethoxysilane. The fluorinated silane compound includes fluoroalkylsilane. The methacryloyloxy silane compound includes 3-methacryloxypropylmethyldimethoxysilane, 3-methacryloxypropyltrimethoxysilane, 3-methacryloxypropylmethyldiethoxysilane and 3-methacryloxypropyltriethoxysilane. The phenyl silane compound includes 3-(4-methacryloyloxyphenol)propyltrimethoxysilane. The acrylic silane compound includes acryloyloxypropyltrimethoxysilane, gamma-acryloxypropyltriethoxysilane, gamma-acryloxypropylmethyldimethoxysilane, gamma-acryloxypropylmethyldiethoxysilane, acryloxyethoxypropyltrimethoxysilane, acryloxyethoxypropyltriethoxysilane, acryloxydiethoxypropyltrimethoxysilane, and acryloxydiethoxypropyltriethoxysilane.

Further, the other invention is the cover member for a push button switch that the hydrophobic silane compound in the invention above is replaced with a silane compound including a functional group that has double couplings between carbons. Therefore, addition reaction occurs between the amino group of the amine silane compound and the above functional group of the hydrophobic silane compound and the hydrophobic framework is added, preventing water from entering into the bonded interface. As the silane compound including a functional group that has double couplings between carbons, a methacryloxy silane compound and an acrylic silane compound are exemplarily cited. The methacryloxy silane compound includes, for example, 3-methocryloxypropylmethyldimethoxysilane, 3-methacryloxypropylmethyltrimethoxysilane, 3-methacryloxypropylmethyldiethoxysilane, and 3-methacryloxypropyltriethoxysilane. The acrylic silane compound includes acryloyloxypropyltrimethoxysilane, gamma-acryloxypropyltriethoxysilane, gamma-acryloxypropylmethyldimethoxysilane, gamma-acryloxypropylmethyldiethoxysilane, acryloxyethoxypropyltrimethoxysilane, acryloxyethoxypropyltriethoxysilane, acryloxydiethoxypropyltrimethoxysilane, and acryloxydiethoxypropyl triethoxysilane.

Further, the other invention is the cover member of a push button switch that hydrophobic silane compound in the invention above is replaced with an acryl group silane compound. Therefore, even when the cover member is used under a high humidity environment, high adhesiveness can be maintained for longer time. This behavior and advantage are brought by the fact that the acryloyl group has higher reactivity compared to the methacryloyl group, and dominantly bonded with the amino group.

Further, the other invention is the cover member for a push button switch that the amino silane compound in the invention above is replaced with 3-(2-aminoethyl) aminopropyltrimethoxysilane, and the acrylic silane compound is acryloyloxypropyltrimethoxysilane. And thus, adding 3-(2-aminoethyl) aminopropyltrimethoxysilane and acryloyloxypropyltrimethoxysilane into the adhesive, causes the cover member of the push buttons to achieve superior adhesiveness and humidity resistance. When addition reaction occurs between the amino group of the 3-(2-aminoethyl)aminopropyltrimethoxysilane and the acryloyl group of the acryloyloxypropyltrimethoxysilane due to the above addition, the added acryloyloxypropyltrimethoxysilane forms a hydrophobic framework, preventing water from entering into the bonded interface.

Also, in addition to the invention above, in the other invention, the cover member of the push buttons switch includes an adhesive layer in which two kinds of the silane compounds are added to the optical curing resin as 100 Per Hundred Resin (PHR) and the total amount of these silane compounds is greater or equal to 0.5 PHR and 7.0 PHR or less. When the total amount of the two kinds of silane compounds becomes 0.5 PHR or more and 7.0 PHR or less while the optical curing resin is as 100 PHR, it is possible to further increase the stability of adhesiveness of the cover member of the push button switch.

According to the other invention, a method of manufacturing a cover member for a push button switch that includes a resin key top and a silicone rubber key sheet integrated with the resin key top, comprises: heating an adhesive including an optical curing resin, an amine silane compound, and a hydrophobic silane compound to the range from 15 degrees C. or more to 30 degrees C. or less; coating the adhesive onto at least one of the adhesive surfaces of the resin key top and the silicone rubber key sheet; bonding the resin key top with the silicone rubber key sheet through the adhesive: and curing the adhesive layer by irradiating ultraviolet light to the adhesive so that the area of the adhesive layer becomes one third or more of the adhesive areas of the resin key top and the silicone rubber key sheet.

Adopting this method of the invention makes it easily to manufacture the cover switch member for a push bottom switch with high adhesiveness, which can endure long-term usage, with a low manufacturing cost. When the adhesive is heated to 15 degrees C. or more and 30 degrees C. or less, the viscosity of the adhesive can be controlled to desired range, and the adhesive layer can be formed easily with its area that is one third or more compared to the bonded area. As a result, the cover member of the push button switch with superior adhesiveness can be achieved.

For the resin material of the cover member of the push button switch related to the aspect of the invention, a polycarbonate resin, an acryl resin, an epoxy resin, a styrene resin, a polyester resin, a polyurethane resin, a polyamide resin, a polyolefin resin, a silicon resin, an acrylonitril/butadiene/styrene resin (ABS resin), a polymethylmethacrylate resin or the like can be preferably used. The polycarbonate resin is yet further preferable. But, the above resin materials are nothing more than some examples and other resin materials may be used. As resin materials, one or more kinds of the above resin materials may be used or two or more kinds of mixture of them may be used.

Although there are several kinds of photo-curing resins for the cover member of the push button switch related to the aspect of the invention, such as, resins cured by visible light, ultraviolet light, or the like, curing resin is more desirable in view of the ease of manufacture since the visible light curing resin is cured even with an electrical lamp.

The present invention is able to provide a cover member for a push bottom switch having excellent adhesiveness, durabilities for long-term usage and humidity resistance and manufacturing the same.

### BRIEF DESCRIPTION OF THE DRAWINGS

FIG. 1 is a cross sectional view of the cover member for push button switch 1 regarding a first embodiment.

FIG. 2 is a flow chart of manufacturing processes of the cover member for push button switch 1 regarding the first embodiment of the invention.

FIGS. 3A to 3I are diagrams showing states of manufacturing the cover member for a push button switch regarding the first embodiment of the invention.

FIG. 4 is a figure showing the procedure of coating an adhesive using a movable transfer pin in the manufacturing procedure of the cover member of a push button switch related to the first embodiment of the invention

FIGS. 5A to 5C are figures showing the details of the transferring in FIG. 4.

FIG. 6 is a figure showing the scene where an adhesive was dropped on a heterogeneous layer by the procedure shown in FIG. 4.

FIGS. 7A to 7C are pattern diagrams of the adhesive layer of the cover member of a push button switch shown in FIG. 1 looking from bottom side of the silicone rubber key sheet. FIG. 7A is the pattern diagram that shows the state in which the adhesive layer area covers more than two thirds of the area of the modified layer of silicone rubber key sheet, FIG. 7B is the pattern diagram that shows the state in which the adhesive layer area covers more than one third and less than two thirds of the modified layer area, and FIG. 7C is the pattern diagram that shows the state in which the adhesive layer area covers less than one third of the modified layer area.

FIG. 8 is a cross sectional view of the cover member for push button switch 1 regarding a second embodiment.

FIGS. 9A to 9I are diagrams showing states of manufacturing the cover member for a push button switch regarding the second embodiment of the invention.

FIG. 10 is a cross sectional view of the cover member for push button switch 1 regarding a modification.

FIG. 11 is a schematic diagram showing a method of evaluating the adhesiveness of the cover member for a push button switch in Examples and Comparative Example of the invention.

### DETAILED DESCRIPTION OF THE PRESENT INVENTION

The following reference numerals are used in the following description of the present invention.
1: Cover member for push button switch,
5: Resin key top,
9: Adhesive,
10: Adhesive layer,
11: Modified layer,
20: Silicone rubber key sheet,

Preferred embodiments of the present invention regarding a cover member for a push bottom switch and a method of manufacturing the same will be explained with referring to drawings. But, the invention is not limited to preferred embodiments described below.

### First Embodiment

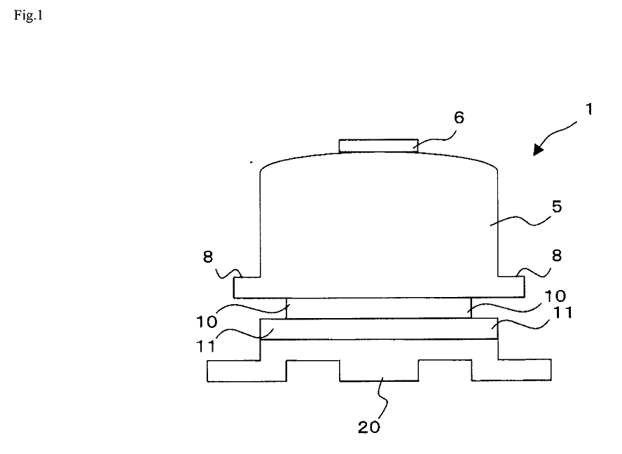

FIG. 1 is a cross sectional view of the cover member for push button switch 1 regarding a first embodiment, hatched lines in the constructional element will be omitted for purpose of viewability.

As shown in FIG. 1, the cover member for push button switch 1 mainly comprises a resin key top 5, a silicone rubber key sheet 20, an adhesive layer 10 which bonds the resin key top 5 with the silicone rubber key sheet 20.

The resin key top 5 is a resin-molded component and also, it is a base of the cover member for push button switch 1. As a material for the resin key top 5, polycarbonate is preferred; however, resin other than polycarbonate, for an example, acrylic type resin can also be applied. A flange 8 having an area larger than the area of an upside portion from it, is formed on the bottom part of the resin key top 5. By forming the flange 8, the cover member for push button switch 1 enables to be pushed properly without protruding out of a casing when the cover member for push button switch 1 is positioned inside the casing of an electric device,

A printing layer 6, comprising characters, figures, or symbols, is formed and located on the top surface of the resin key top 5. Here, a well-known method (such as various printing, coating or plating) can be used for forming the printing layer 6. An additional transparent resin coating layer may be formed on the surface of printing layer 6 in order to protect the printing layer 6.

The silicone rubber key sheet 20 is an elastomer including a silicone rubber compound and a cross linking agent. The silicone rubber key sheet 20 shows the low adhesiveness with the resin key top 5. For this reason, ultraviolet light is irradiated onto the bonded surface of the resin key top 5 in the silicone rubber key sheet 20, forming a modified layer 11 on the surface of the bonded adhesive layer. The irradiation of ultraviolet light improves the adhesiveness between the silicone rubber key sheet 20 and the resin key top 5, robustly bonding the silicone rubber key sheet 20 with resin key top 5 with the adhesive layer 10.

The adhesive layer 10 that bonds the resin key top 5 with the silicone rubber key sheet 20 is located between the resin key top 5 and the modified layer 11, and is formed by curing the adhesive comprising a photo-curing resin, an amine silane compound and a hydrophobic silane compound. A hydrophobic acrylic silane compound is preferred for the hydrophobic silane compound as one of the component of the adhesive. In particular, acryloyloxypropyltrimethoxysilane is preferred for hydrophobic acrylic silane compound. Further, 3-(2-aminoethyl) aminopropyltrimethoxysilane is preferred for the amine silane compound as one of the component of the adhesive.

Next, a process for manufacturing the cover member for push button switch 1 regarding a first embodiment of this invention will be explained.

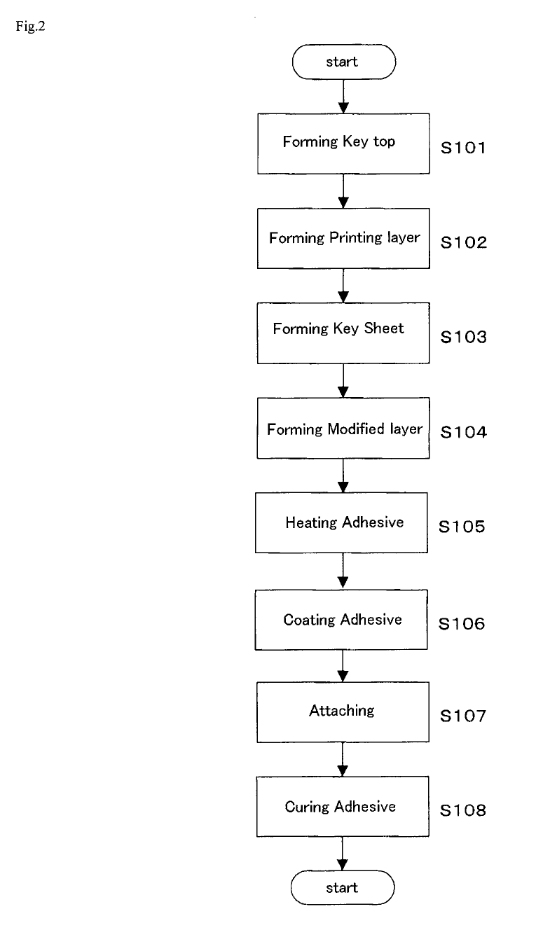

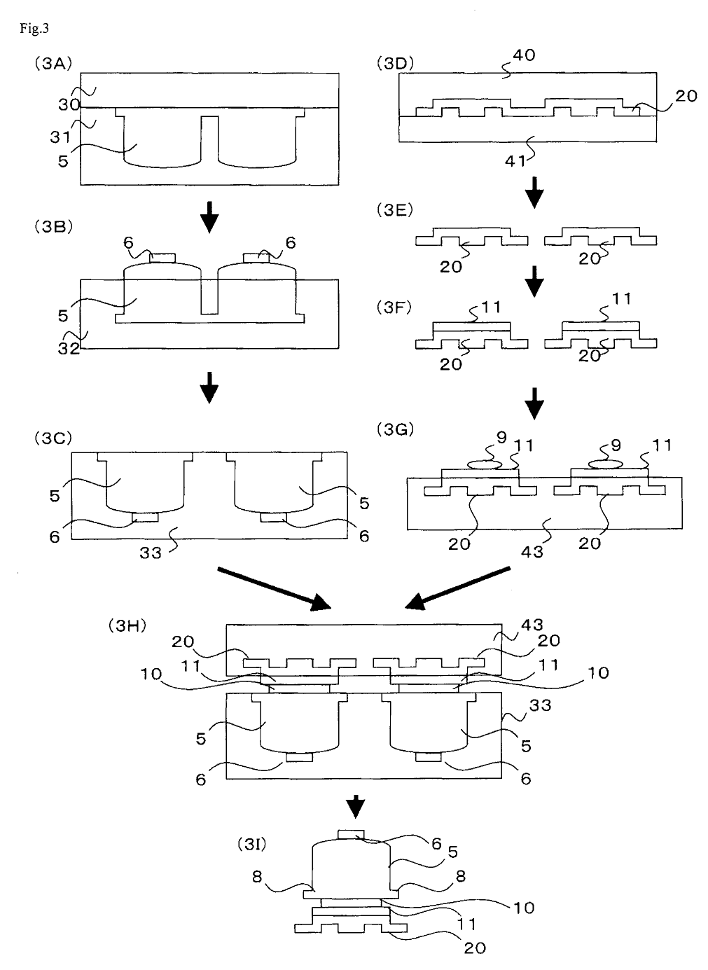

FIG. 2 is a flow chart of manufacturing processes of the cover member for push button switch 1 regarding the first embodiment of the invention. FIGS. 3A to 3I are process diagrams in steps of manufacturing the cover member for push button switch 1 regarding the first embodiment of the invention.

First, the resin key top 5 is formed (step S101). As shown in FIG. 3(3A), it is injection-molded using the molds 30 and 31. Polycarbonate as a resin material is preferably used in the embodiment and the injection-molding method is implemented as a molding method for this embodiment. But, other resin material as well as other molding method may be used.

Next, as shown in FIG. 3 (3B), the molded resin key top 5 is kept in a printing jig 32, and the printing layer 6 is formed on the top surface of the resin key top 5 (step S102). In the embodiment, symbols, numbers, or letters are printed and then, drying it, so that the printing layer 6 is formed. Next, unnecessary portions such as runner, gates or the like in the formed resin key top 5 are removed and the resin key top 5 is fixed to a jig 33 as shown in FIG. 3 (3C). The printing layer 6 may cover the surface other than that of bottom part of the resin key top 5.

Next, the silicone rubber key sheet 20 is molded (step S103). In the embodiment, as shown in FIG. 3 (3D) as well as FIG. 3 (3E), the raw material made of a silicone rubber compound and a cross linking agent is heated and molded, and such unnecessary portion as burrs or the like on the resulted sheet are cut and removed. It is preferred that the silicone rubber key sheet 20 to be transparent as highly as possible since light is irradiated from the bottom of the silicone rubber key sheet 20. The compound ratio of a silicone rubber compound to a cross linking agent is not especially specified. Further, a colorant, a heat resisting additive, a mildew proofing agent, light diffusion agent or the like may be added to the material of the silicone rubber key sheet 20 on the premise that they ensure transparency.

Next as shown in FIG. 3 (3F), the adhesive surface of the resin key top 5 in the silicone rubber key sheet 20 is modified so that the modified layer 11 is formed (step S104.) In this embodiment, ultraviolet light is irradiated onto the bonded surface of the silicone rubber key sheet 20 so as to break the chemical bond of the surface layer, causing active oxygen isolated from ozone generated by the ultraviolet light to bond with molecules which is the broken bond of the surface layer, and forming a highly hydrophilic functional group (for example, a active group such as a carboxyl group, a silanol group or the like). Consequently, stable chemical bonding with the adhesive layer 10 can be formed, and the cover member for push button switch 1 having highly adhesive can be manufactured. As alternative methods of forming a modified layer, corona discharge processing, flame processing, plasma processing, or electron beam processing may be preferably implemented other than ultraviolet light exposure. Considering the manufacturing cost and ease in handling, it is more preferable to implement ultraviolet light exposure processing.

Subsequently, the adhesive 9 including a photo-curing resin, amine silane compound, and hydrophobic silane compound is heated (step S105). In this embodiment, preferred temperature of the adhesive 9 is in the range from 15 degrees C. or more to 30 degrees C. or less. At the temperature 15 degrees C. or more, the adhesive 9 can be sufficiently spread because of the decrease in the viscosity of the adhesive 9, Under the temperature 30 degrees C. or less, the sufficient volume of the adhesive 9 in relation to the area of the bonded surface can be maintained. A resin curable by visual light or an ultraviolet light is preferred for photo-curing, and considering the ease of manufacture, an ultraviolet curable resin is more preferred.

3-(2-aminoethyl) aminoproyl trimethoxysilane, which is one of the constituents of the adhesive 9, maintains the bond with a resin based on an amino organic functional group, while it stably and chemically bonds with the hydroxyl group of a modified layer 11 based on a hydroxyl group generated by hydrolysis of a hydrolysable group. Further, acryloyloxypropyl trimethoxysilane, which is one of the constituents of the adhesive 9, is chemically reacted with an acryl group and an amino group, being added to 3-(2-aminoethyl) aminopropyl trimethoxysilane of an amine silane compound. Because of the hydrophobic framework of acryloyloxypropyl trimethoxysilane, it can keep out water from getting into the bonded interface. Furthermore, self-hydrolysis and progression of condensation reaction can be prevented due to 3(2-aminoethyl) aminopropyl trimethoxysilane. As the result of them, the adhesiveness and humidity resistance of the cover member for push button switch 1 become to be improved.

It is preferred that the total amount of these two silane compounds be in the range from 0.5 PHR or more to 0.7 PHR or less compared to the optical curing resin, and it is further preferred that it be in the range from 0.5 PHR or more to 2.0 PHR or less. The reason is the following. If the total amount of the silane compound is 7 PHR or less, viscosity dose not increase quickly, and adhesiveness can be improved. On the other hand, if the total amount of silane compound is 0.5 PHR or more, an active group formed by hydrolysis reaction relatively increases, resulting in higher associativity between the modified layer 11 and a hydroxyl group of silanol.

Next, as shown in FIG. 3 (3G), the heated adhesive 9 is coated on the surface of the modified layer 11 of the silicone rubber key sheet 20 which is fixed to a jig 43. (Step S106) In this embodiment, the jig that is equipped with a movable transfer pin is used to coat the adhesive 9.

Next, the resin key top 5 is attached with the silicone rubber key sheet 20 (step S107). As shown in FIG. 3 (3H), in this embodiment, the jig 33 that fixes the resin key top 5 is opposed to and attached with the silicone rubber key sheet 20 fixed on the jig 43. This attachment enables the adhesive 9 to spread out on the bonded surfaces of the resin key top 5 and the silicone rubber key sheet 20.

Next, the adhesive 9 is cured using ultraviolet light irradiation (step S108). As shown in FIG. 3 (3H), an ultraviolet light reaches the adhesive 9 from the bottom surface of the silicone rubber key sheet 20, resulting in the formation of the adhesive layer 10. An ultraviolet light is irradiated under the conditions of wavelength of 300-450 nm and integrated light intensity of 2000 mJ/cm².

Finally, as shown in FIG. 3 (3I), the jigs 33, 34 are excluded, then the cover member for push button switch 1 having high adhesiveness and humidity resistance is completed.

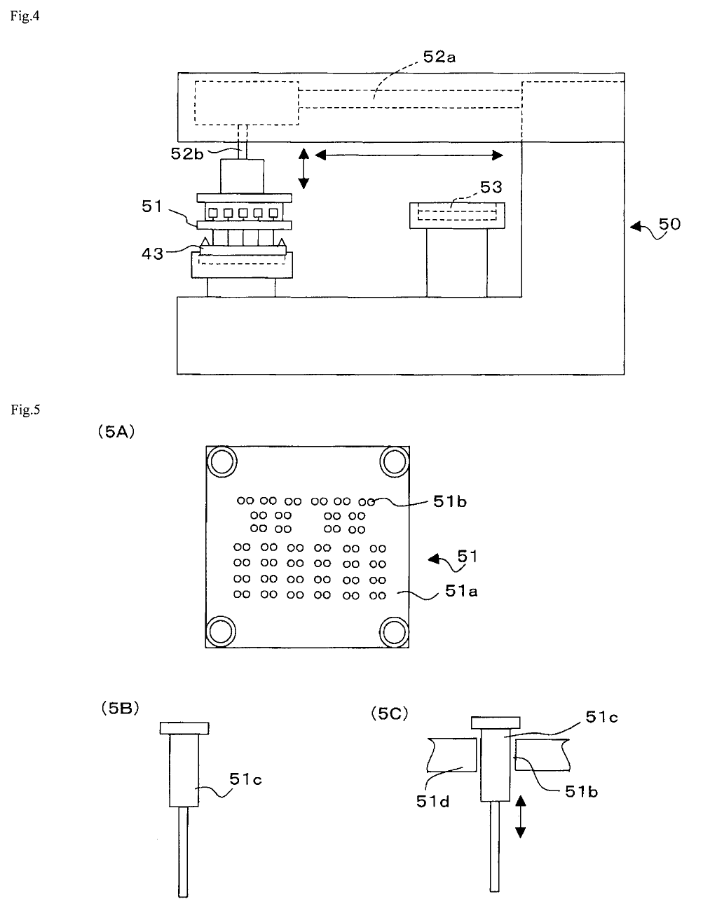

FIG. 4 is a figure showing the procedure of coating the adhesive 9 using a movable transfer pin 51c in the manufacturing procedure of the cover member for push button switch 1 related to the first embodiment of the invention.

First a transferring jig 51 is moved to the side of an adhesive tank 53, and the tip of the transferring jig 51 of about 0.5 mm˜1 mm is immersed into the adhesive 9 in the adhesive tank 53. Then, after a certain amount of the adhesive 9 is attached to the transferring jig 51, the transferring jig 51 is moved to the upside of the jig 43 that retains the silicone rubber key sheet 20 by an air cylinder 52a. The jig 43 is placed at a predetermined position. Subsequently, the transferring jig 51 is descended toward the jig 43 by the air cylinder 52b, and the adhesive 9 is transferred to the modified layer 11 by contacting the tip (a part immersed to the adhesive 9) of the transferring jig 51 with the modified layer 11.

FIGS. 5A to 5C are figures showing the details of the transferring jig 51 in FIG. 4. In FIG. 5 (5A), the transferring jig 51 is formed by creating a hole 51b with a diameter of about from 1 to 3 mm on the aluminum plate 51a corresponding to the location of the silicone rubber key sheet 20. A movable transfer pin 51c is inserted in the hole 51b (FIG. 5(5C)).

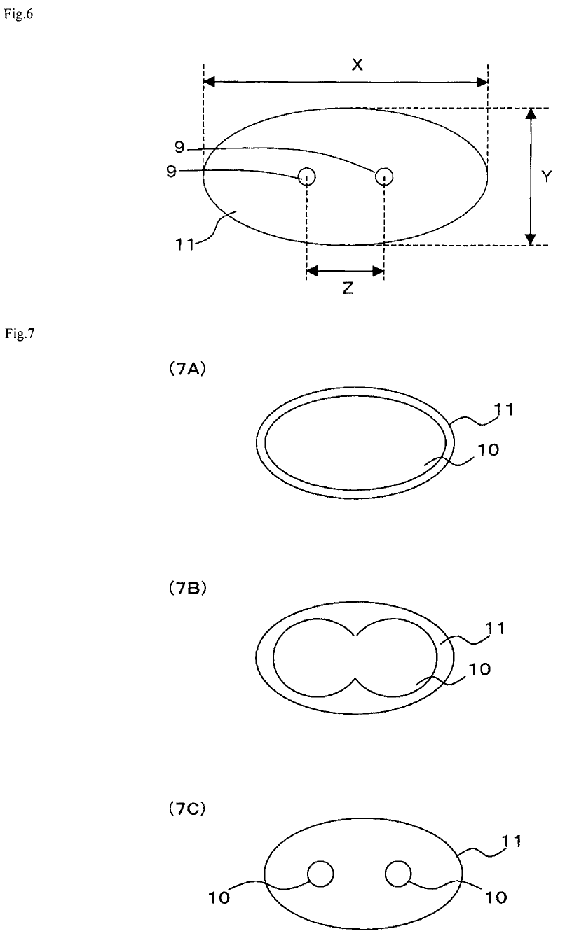

FIG. 6 is a figure showing the state in which the adhesive 9 is dropped on the modified layer 11.

The shape of the modified layer 11 is an ellipse with the dimension of a major axis (X) at 10 mm and a minor axis (Y) at 5 mm. As shown in FIG. 6, the distance (Z) between the two spots of the adhesives 9 is 3.5 mm. The adhesive 9 is applied to the modified layer 11 so that the center between the two spots is the center of the modified layer 11.

FIGS. 7A to 7C are pattern diagrams of the adhesive layer 10 looking from the bottom side of the silicone rubber key sheet 20. FIG. 7A is a pattern diagram that shows the state in which the area of the adhesive layer 10 covers two thirds or more of the area of the modified layer 11 of the silicone rubber key sheet 20. FIG. 7B is a pattern diagram that shows the state in which the area of the adhesive layer 10 covers one third or more and less than two thirds the modified layer 11. FIG. 7C is a pattern diagram that shows the state in which the area of the adhesive layer 10 covers one third or less of the modified layer 11.

If the area of the adhesive layer 10 is one third or more of the bonded surface of the modified layer 11, the printing layer 6 can be clearly recognized due to the increase in permeability of light when light is irradiated from the bottom side, while adhesive strength is improved. Namely, the adhesiveness and the permeability of the cover member can be enhanced if the adhesive layer 10 is formed shown in FIG. 7 (7A) or FIG. 7 (7B). In order to form the adhesive layer 10, it is preferred that the viscosity of the adhesive 9 is in the range from 4.2 dPa·s or more to 1.75 dPa·s or less, Otherwise, it is more preferable that it be in the range from 3.00 dPa·s or more to 1.75 dPa·s or less. Further, in order to achieve the given viscosity range, it is preferable that the temperature of the adhesive 9 in the embodiment is set in the range from 15 degrees C. or higher to 30 degrees C. or less. Otherwise, it is more preferable that it is in the range from 20 degrees C. or higher and 30 degrees C. or less. The adhesive 9 may be coated with spray instead of the movable transfer pin 50. The adhesive 9 may be coated on the bonded surface of the resin key top 5 instead of the surface of the silicone rubber key sheet 20. Alternatively, the adhesive 9 may be coated on the both bonded surfaces of the resin key top 5 and the surface of the silicone rubber key sheet 20.

### Second Embodiment

Next, the cover member for push button switch 1 and a process for manufacturing the same regarding a second embodiment of the invention will be explained. Here, the same reference numerals used in the first embodiment will be applied to components in the second embodiment also cited in the first embodiment and their explanation will be omitted.

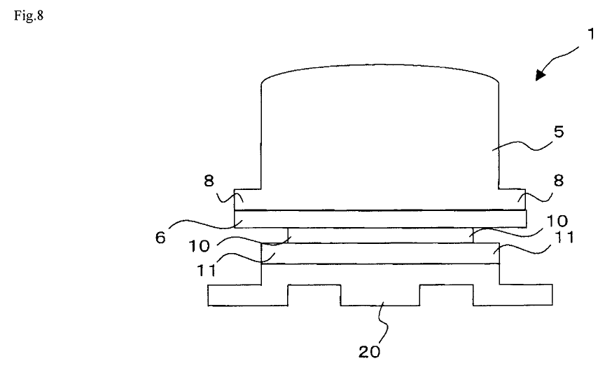

FIG. 8 is a cross sectional view of the cover member for push button switch 1 regarding the second embodiment.

As shown in FIG. 8, the cover member for push button switch 1 mainly comprises the resin key top 5, the silicone rubber key sheet 20, the adhesive layer 10 which bonds the resin key top 5 with the silicone rubber key sheet 20.

The resin key top 5 includes the printed layer 6 having characters, figures or symbols on the back surface of the key top 5. Here, a resin layer may be formed on the surface of the printed layer 6 in order to reduce the influence of the adhesive layer 9 to the external appearance of the printed layer 6. An ultraviolet curable ink may be used for forming the printed layer 6. But, the ultraviolet curable ink is nothing more than an example and other inks may be used.

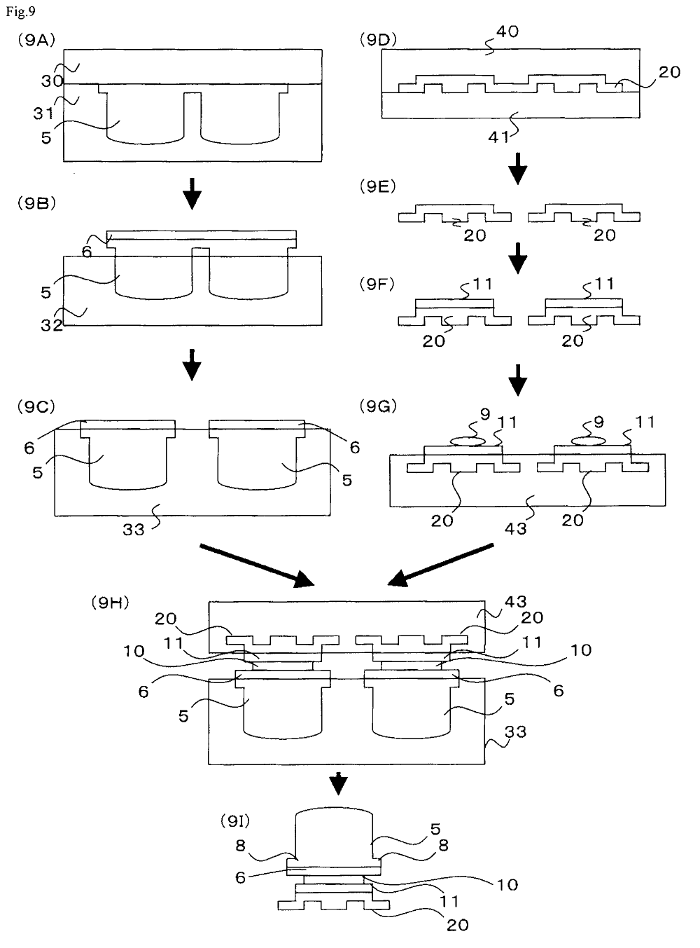

FIGS. 9A to 9I are diagrams showing the states of steps of manufacturing the cover member for push button switch 1 regarding the second embodiment of the invention.

The method of manufacturing the cover member for push button switch 1 regarding the second embodiment is basically the same of manufacturing the cover member for push button switch 1 regarding the first embodiment except that there is the printed layer 6 having characters, figures or symbols on the back surface of the key top 5 is formed, as shown in FIG. 9(9B).

More specifically, as shown in FIG. 9(9A), the resin key top 5 is formed by injection-molding with molds 30 and 31. Then, as shown in FIG. 9 (9B), the printed layer 6 is formed on the back surface of the key top 5. Next, as shown in FIG. 9 (9C), unnecessary portions such as runner, gates or the like in the formed resin key top 5 are removed and the resin key top 5 is fixed to the jig 33. On the other hand, as shown in FIG. 9 (9D), a material composed of a silicone rubber compound and a cross linking agent is heated and molded. Then, as shown in FIG. 9 (9E), unnecessary portions such as burr or the like are cut and removed from the silicone rubber key sheet 20. Next, as shown in FIG. 9 (9F), the adhesive layer surface of the resin key top 5 in the silicone rubber key sheet 20 is modified so that the modified layer 11 is formed. Next, as shown in FIG. 9 (9G), the heated adhesive layer 9 is coated on the surface of the modified layer 11 of the silicone rubber key sheet 20 which is fixed to the jig 43. Next, as shown in FIG. 9 (9H), the jig 33 fixing the resin key top 5 is opposed to and bonded with the jig 43 fixing the silicone rubber key sheet 20, so that the cover member for push button switch 1 is finally formed as shown in FIG. 9 (9I.)

The various embodiments of the cover member for push button switch 1 regarding the present invention have been explained in the above. But the cover member for push button switch 1 regarding the invention is not limited to the above embodiments, but may be modified in any other ways.

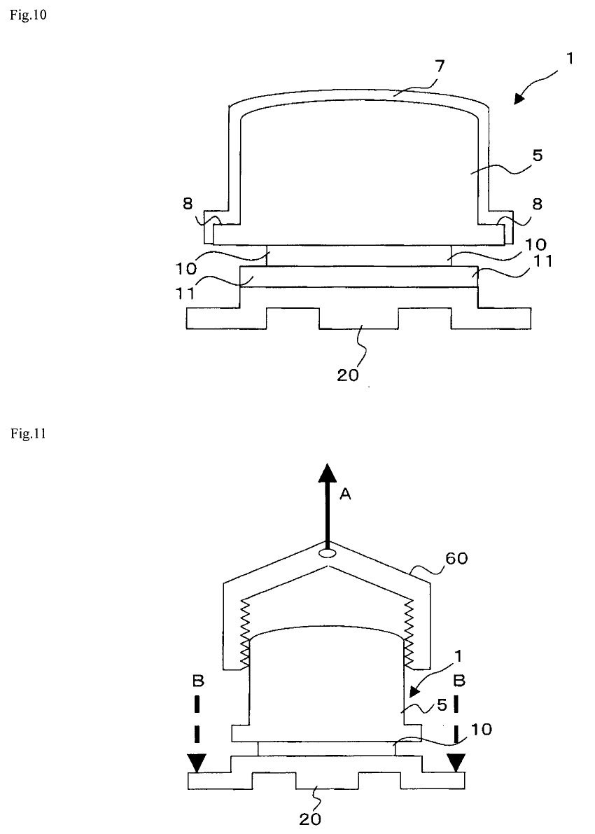

For example, a film 7 may be attached to the surface of the resin key top 5. FIG. 10 is a cross sectional view showing the cover member for push button switch 1 including the resin key top 5 with a film 7 as a modification of the embodiment.

As shown in FIG. 10, the cover member for push button switch 1 including the resin key top 5 with the film 7 is formed by placing the film 7 on the outer surface of the resin key top 5 and integrally molding them. If the film 7 including drawing patterns is used, an decorative layer such as a pattern, a character or the like can be formed on the surface of the resin key top layer 5.

In the flow chart shown in FIG. 2, steps S103 to S106 may be performed in parallel with steps S101 to S102 or before steps S101 to S102.

Further, the weight ratio of an amine silane compound to a hydrophobic silane compound in the adhesive layer 9 may not be 1:1, but 1:2, 1:3, 2:1, 3:1 or the like. But, the ratio is preferably 1:1.

### EXAMPLES

### 1. Examining Adhesive Layer Area

An optical curing resin, 3-(2-aminoethyl)aminopropyltrimethoxysilane as an amine silane compound, and acryloyloxypropyltrimethoxysilane as an hydrophobic acrylic silane compound were prepared as an adhesive layer. The amount of 342-aminoethyl)aminopropyltrimethoxysilane was 0.5 PHR, the amount of acryloyloxypropyltrimethoxysilane was 0.5 PHR while the amount of the optical curing resin was 100 PHR. The above adhesive layer was heated within the range from 5 degrees C. or more to 45 degrees C. or less and coated on the adhesive layer surface of the modified silicone rubber key sheet by using the movable transfer pin described above. Then, the key top made of polycarbonate was bonded with the key sheet made of silicone rubber.

The way of spreading the adhesive layer was checked with eyes from the backside of the key sheet made of a silicone rubber after the key top was bonded with the key sheet. As shown in FIG. 7 (7A), a first case where the ratio of spreading the adhesive layer to the adhesive layer area was two thirds or more was marked as “circle”, and as shown in FIG. 7 (7B), a second case where the ratio of spreading the adhesive layer to the adhesive layer area was in the range from one third or more to less than two thirds was marked as “triangle”. Further, a third case where the ratio of spreading the adhesive layer to the adhesive layer area was in the range of less than one third was marked as “x”. The viscosity of the adhesive layer was checked by using a viscometric device (viscotester VT-04 (Rotor No. 3) manufactured by RION Co. Ltd.)

Table 1 shows the states of the adhesive layer at each temperature.

TABLE 1

| Temperature | Viscosity | Transferred Amount | Outer View |
|---|---|---|---|
| (° C.) | (dPa · s) | (mg) | Spread of Adhesive |
| 5 | 6.75 | 7.4 | X |
| 10 | 5.25 | 7.6 | X |
| 15 | 4.25 | 7.2 | Δ |
| 20 | 3.00 | 7.2 | ◯ |
| 25 | 2.25 | 7.4 | ◯ |
| 30 | 1.75 | 7.8 | ◯ |
| 35 | 1.50 | 4.4 | X |
| 40 | 1.25 | 4.6 | X |
| 45 | 1.00 | 4.4 | X |

As clearly shown in Table 1, it is preferable that the temperature of the adhesive to be in the range from 15 degrees C. or more to 30 degrees C. or less in considering the appearance of it. The temperature is more preferably in the range from 20 degrees C. or more to 30 degrees C. or less. When the temperature was under 15 degrees C., the adhesive layer was not sufficiently spread out after the key top was bonded with the key sheet because of its high viscosity. On the other hand, when the temperature was 35 degrees C. or more, the viscosity of the adhesive layer became too low, causing the amount of the adhesive layer not to be sufficiently transferred to the adhesive layer area and spread unevenly after the key top was bonded with the key sheet. Further, the optical curing resin was chemically reacted with a silane compound, bringing the viscosity to increase or the adhesiveness of the key top with the key sheet to include a defect.

### 2. Functional Test of Adhesiveness

A. Manufacturing Processes of Cover Member for Push Button Switch

Table 2 shows blended ratios of adhesive layers in each Example and Comparative Example.

TABLE 2

| | | 3-(2-aminoethyl) | |
|---|---|---|---|
| | | aminopropyl | Acryloyloxypropyl |
| | Ultraviolet Curable | trimethoxysilane | trimethoxysilane |
| | Adhesive/PHR | (KBM-603)/PHR | (KBM-5103)/PHR |
| Example 1 | 100 | 0.25 | 0.25 |
| Example 2 | 100 | 0.5 | 0.5 |
| Example 3 | 100 | 1.0 | 1.0 |
| Example 4 | 100 | 2.5 | 2.5 |
| Example 5 | 100 | 3.5 | 3.5 |
| Comparative Example 1 | 100 | 0.25 | — |
| Comparative Example 2 | 100 | 0.5 | — |
| Comparative Example 3 | 100 | 1.0 | — |
| Comparative Example 4 | 100 | 2.5 | — |
| Comparative Example 5 | 100 | 3.5 | — |
| Comparative Example 6 | 100 | — | 0.25 |
| Comparative Example 7 | 100 | — | 0.5 |
| Comparative Example 8 | 100 | — | 1.0 |
| Comparative Example 9 | 100 | — | 2.5 |
| Comparative Example 10 | 100 | — | 3.5 |
| Comparative Example 11 | 100 | — | — |
| Comparative Example 12 | 100 | 0.05 | 0.05 |
| Comparative Example 13 | 100 | 5.0 | 5.0 |

### Example 1

A polycarbonate resin (CALIBRE™ 301-22 manufactured by Sumitomo-Dow Ltd.) is injected and molded so that a resin key top is formed. The printing layer in the upper surface of the resin key top is formed by using an evaporating and drying ink (CAV Meiban manufactured by Seiko-Advance Co. Ltd.) Further, a material composed of 100 PHR of a silicone rubber pound (DY 32-6014U manufactured by Dow Corning Toray Co. Ltd) and 0.5 PHR of a cross linking agent (RC-8 manufactured by Dow Corning Toray Co. Ltd) is pressed and molded under the condition of the molding temperature: 180 degrees C., the molding time: 5 min. and the molding pressure: 180 kg/cm². Then, the pressed and molded material was dried under the condition of keeping 200 degrees C.,—during 60 min. so that the silicone rubber key sheet is formed.

Next the ultraviolet light including its wavelengths 184.9 nm and 253.7 nm were irradiated onto the silicone rubber key sheet under the condition of 1200 mJ/cm² by using a batch type ultraviolet light cleaning processor (VUM-3073-B manufactured by Oak Manufacturing Co. Ltd) so that the adhesive layer surface of the silicone rubber key sheet is modified. Subsequently, 0.25 PHR of 3-(2-aminoethyl)aminopropyltrimethoxysilane (KBM-603 manufactured by Shin-Etsu chemical Co Ltd.) and 0.25 PHR of acryloyloxypropyltrimethoxysilane (KBM-5103 manufactured by Shin-Etsu chemical Co Ltd.) were blended into the ultraviolet curable adhesive (TB3042H manufactured by ThreeBond Co. Ltd.). This blended material was filled into an adhesive tank placed on a temperature adjustment board, and heated with 25 degrees C.

Next, the adhesive layer in the adhesive layer tank is applied to the modified layer of the silicone rubber key sheet with using a movable transfer pin. Then, the resin key top was bonded with the silicone rubber key sheet by using a jig. Finally, the ultraviolet light including its wavelengths of 300 nm and 450 nm were irradiated onto the silicone rubber key sheet with the condition of 2000 mJ/cm² by using an ultraviolet light irradiation conveyer (Metal Halide 120 W/cm, M015L312 manufactured by Eye Graphics Co. Ltd.) The resin key top was bonded with the silicone rubber key sheet by curing the ultraviolet curable adhesive layer so that the cover member for the push button switch was completed.

### Example 2

The cover member for the push button switch was manufactured by the same process conditions of the Example 1 except that 0.5 PHR of 3-(2-aminoethyl)aminopropyltrimethoxysilane (KBM-603) and 0.5 PHR of acryloyloxypropyltrimethoxysilane (KBM-5103) were blended into the ultraviolet curable adhesive.

### Example 3

The cover member for a push button switch was manufactured by the same process conditions of the Example 1 except that 1.0 PHR of 3-(2-aminoethyl)aminopropyltrimethoxysilane (KBM-603) and 1.0 PHR of acryloyloxypropyltrimethoxysilane (KBM-5103) were blended into the ultraviolet curable adhesive.

### Example 4

The cover member for the push button switch was manufactured by the same process conditions of the Example 1 except that 2.5 PHR of 3-(2-aminoethyl)aminopropyltrimethoxysilane (KBM-603) and 2.5 PHR of acryloyloxypropyltrimethoxysilane (KBM-5103) were blended into the ultraviolet curable adhesive.

### Example 5

The cover member for the push button switch was manufactured by the same process conditions of the Example 1 except that 3.5 PHR of 342-aminoethyl)aminopropyltrimethoxysilane (KBM-603) and 3.5 PHR of acryloyloxypropyltrimethoxysilane (KBM-5103) were blended into the ultraviolet curable adhesive.

### Comparative Example 1

The cover member for the push button switch was manufactured by the same process conditions of the Example 1 except that acryloyloxypropyltrimethoxysilane (KBM-5103) was not blended.

### Comparative Example 2

The cover member for the push button switch was manufactured by the same process conditions of the Example 2 except that acryloyloxypropyltrimethoxysilane (KBM-5103) was not blended.

### Comparative Example 3

The cover member for the push button switch was manufactured by the same process conditions of the Example 3 except that acryloyloxypropyltrimethoxysilane (KBM-5103) was not blended.

### Comparative Example 4

The cover member for the push button switch was manufactured by the same process conditions of the Example 4 except that acryloyloxypropyltrimethoxysilane (KBM-5103) was not blended.

### Comparative Example 5

The cover member for the push button switch was manufactured by the same process conditions of the Example 5 except that acryloyloxypropyltrimethoxysilane (KBM-5103) was not blended.

### Comparative Example 6

The cover member for the push button switch was manufactured by the same process conditions of the Example 1 except that 3-(2-aminoethyl)aminopropyltrimethoxysilane (KBM-603) was not blended.

### Comparative Example 7

The cover member for the push button switch was manufactured by the same process conditions of the Example 2 except that 342-aminoethyl)aminopropyltrimethoxysilane (KBM-603) was not blended.

### Comparative Example 8

The cover member for the push button switch was manufactured by the same process conditions of the Example 3 except that 342-aminoethyl)aminopropyltrimethoxysilane (KBM-603) was not blended.

### Comparative Example 9

The cover member for the push button switch was manufactured by the same process conditions of the Example 4 except that 3-(2-aminoethyl)aminopropyltrimethoxysilane (KBM-603) was not blended.

### Comparative Example 10

The cover member for the push button switch was manufactured by the same process conditions of the Example 5 except that 3-(2-aminoethyl)aminopropyltrimethoxysilane (KBM-603) was not blended.

### Comparative Example 11

The cover member for the push button switch was manufactured by the same process condition of the Example 1 except that 3-(2-aminoethyl)aminopropyltrimethoxysilane (KBM-603) and acryloyloxypropyltrimethoxysilane (KBM-5103) were not blended.

### Comparative Example 12

The cover member for the push button switch was manufactured by the same process conditions of the Example 1 except that 0.05 PHR of 342-aminoethyl)aminopropyltrimethoxysilane (KBM-603) and 0.05 PHR of acryloyloxypropyltrimethoxysilane (KBM-5103) were blended into the ultraviolet curable adhesive.

### Comparative Example 13

The cover member for the push button switch was manufactured by the same process conditions of the Example 1 except that 5.0 PHR of 342-aminoethyl)aminopropyltrimethoxysilane (KBM-603) and 5.0 PHR of acryloyloxypropyltrimethoxysilane (KBM-5103) were blended into the ultraviolet curable adhesive.

B. Method of Evaluating Adhesiveness of Cover Member for Push Button Switch

The following tests were performed so as to evaluate the adhesiveness of the manufactured cover member for a push button switch. The boiling test was carried out, so the cover member for a push button switch as a test object was put into boiled water. Further, as a high temperature and high humidity test, the cover member was placed under the condition of temperature 65 degrees C. and relative humidity 95% RH for 240 hrs. Further, the adhesive strength of the cover member for a push button switch was examined by using an adhesiveness measuring device (FGC-10 manufactured by Nidec-shimpo Co. Ltd.)

FIG. 11 is a schematic diagram showing a method of evaluating the adhesive strength of the cover member for a push button switch.

As shown in FIG. 11, the upper part of the resin key top 5 was fixed to a clamp 60 and pulled up vertically, toward the upper direction (the arrow A as the direction) with a vertical pulling up speed: 50 mm/min. On the other hand, the silicone rubber sheet 20 is pressed toward the lower direction (the arrow B as a direction) and fixed. The surfaces of the resin key top 5 and the silicone rubber sheet 20 separated each other was viewed by eyes after the above setting. As the result of this test, a first state where the silicone rubber sheet 20 was completely broken was evaluated and marked as “circle”, and a second state where a part of the silicone rubber sheet 20 was broken and separated was evaluated and marked as “triangle”. A third state where the silicone rubber sheet 20 was easily separated from the resin key top was evaluated and marked as “x”.

C. Result of Evaluating Adhesiveness of Cover Member for Push Button Switch

Table 3 shows the results of evaluating the adhesiveness of the cover member for push button switch manufactured under conditions described in Table 2. Each of results in Table 3 corresponds to each of conditions described in Table 2.

TABLE 3

| | | Amount of Coupling Agent/Total PHR | | | | | | | | | | | | | | | | | | | | | | | | | |
|---|---|---|---|---|---|---|---|---|---|---|---|---|---|---|---|---|---|---|---|---|---|---|---|---|---|---|---|
| | | 0.0 | 0.1 | | | | | 0.5 | | | | | 1.0 | | | | | 2.0 | | | | | 5.0 | | 7.0 | | 10 |
| | | Elapsed Time After Blending/hrs | | | | | | | | | | | | | | | | | | | | | | | | | |
| | | 0 | 0 | 4 | 8 | 12 | 24 | 0 | 4 | 8 | 12 | 24 | 0 | 4 | 8 | 12 | 24 | 0 | 4 | 8 | 12 | 24 | 0 | 4 | 0 | 4 | 0 |
| KBM603 | Initial | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | * | ◯ | * | * |
| (A) | Boiling | X | Δ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | | ◯ | | |
| | Test | | | | | | | | | | | | | | | | | | | | | | | | | | |
| | High Temp. | X | X | X | X | X | X | ◯ | Δ | X | X | X | ◯ | Δ | X | X | X | ◯ | Δ | X | X | X | ◯ | | ◯ | | |
| | & Humidity | | | | | | | | | | | | | | | | | | | | | | | | | | |
| | Test | | | | | | | | | | | | | | | | | | | | | | | | | | |
| KBM5103 | Initial | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ |
| (B) | Boiling | X | X | X | X | X | X | X | X | X | X | X | ◯ | Δ | X | X | X | ◯ | Δ | X | X | X | ◯ | Δ | ◯ | Δ | ◯ |
| | Test | | | | | | | | | | | | | | | | | | | | | | | | | | |
| | High Temp. | X | X | X | X | X | X | X | X | X | X | X | X | X | X | X | X | X | X | X | X | X | X | X | X | X | X |
| | & Humidity | | | | | | | | | | | | | | | | | | | | | | | | | | |
| | Test | | | | | | | | | | | | | | | | | | | | | | | | | | |
| A/B | Initial | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | * | ◯ | * | * |
| (1/1) | Boiling | X | Δ | Δ | Δ | X | X | ◯ | ◯ | ◯ | ◯ | ◯ | ◯ | ◯ | ◯ | ◯ | ◯ | ◯ | ◯ | ◯ | ◯ | ◯ | ◯ | | ◯ | | |
| | Test | | | | | | | | | | | | | | | | | | | | | | | | | | |
| | High Temp. | X | X | X | X | X | X | Δ | Δ | Δ | Δ | Δ | ◯ | ◯ | ◯ | ◯ | ◯ | ◯ | ◯ | ◯ | ◯ | ◯ | ◯ | | ◯ | | |
| | & Humidity | | | | | | | | | | | | | | | | | | | | | | | | | | |
| | Test | | | | | | | | | | | | | | | | | | | | | | | | | | |

* Increased Viscosity

As shown in Table 3, the weight ratio of KBM-603 (referred as “A”) to KBM-5103 (referred as “B”) is 1:1. Further, the adhesive including 0.5 to 2.0 PHR of A+B was used for manufacturing the cover members for push button switch (Examples 1 to 3). Such cover members showed excellent adhesiveness and humidity resistance under any environmental conditions. In particular, even if the cover members for push button switch (Examples 1 to 3) were placed for 240 hrs under a high hygrothermal condition, the adhesiveness of the cover members for push button switch (Examples 1 to 3) did not lowered and the cover members showed excellent performances on their adhesiveness.

Further, in a case of the cover members for a push button switch (Example 4 and Example 5) manufactured by using the adhesive, which includes 5 to 7 PHR of A+B, whose the weight ratio A:B is 1:1, the evaluation results of them were slightly inferior to the adhesiveness performances of Examples 1 to 3 though there were no specific defects in their results. These results are considered to be caused by the fact that the amounts of 3-(2-aminoethyl)aminopropyltrimethoxysilane (KBM-603) and acryloyloxypropyl trimethoxysilane (KBM-5103) were relatively large compared to the that of ultraviolet curable adhesive. Hence, it is more preferably considered that the total amount of a silane compound to be 0.5 PHR or more and 2.0 PHR or less for the 100 PHR of the ultraviolet curable adhesive. Here Table 3 shows that the result of a high hygrothermal condition was “triangle” under the condition of 0.5 PHR as the total amount of a silane compound. But there is no practical problem about it.

On the other hand, when the Examples 1 to 5 were compared to the Comparative Examples 1 to 10, the cover members for push button switch manufactured by the conditions of the Comparative Examples 1 to 10 show that the adhesiveness in the initial stage and after dipped into boiling water is preferable, but lowered after the test under a high hygrothermal conditions since only one of 3-(2-aminoethyl)aminopropyl trimethoxysilane (KBM-603) or acryloyloxypropyltrimethoxysilane (KBM-5103) was included in the adhesive layer.

Further, the cover members for a push button switch manufactured by the conditions of the Comparative Example 11 showed that the adhesiveness in the initial stage was good in some degrees but lowered after environmental tests. This result of the adhesiveness is caused by the fact that water is induced into the adhesive layer composed of the ultraviolet curable adhesive. Further, the cover members for a push button switch manufactured by the conditions of the Comparative Example 12 showed that the adhesiveness was lowered because of small amount of a silane compound. On the other hand, the cover members for a push button switch manufactured by the conditions of the Comparative Example 13 showed that viscosity was excessively increased because of too much amount of a silane compound, causing the ultraviolet curable adhesive to easily chemical react with a silane compound. As the result, the adhesiveness of the cover member for a push button switch was lowered.

Table 4 shows the evaluation results of the changes over time regarding a methoxy group in each of adhesive layers. These adhesive layers are: a first one in which only KBM-603 was added into the ultraviolet curable adhesive (the ultraviolet curable adhesive: KBM-603=100 PHR:1 PHR), a second one in which only KBM-5103 was added into the ultraviolet curable adhesive (the ultraviolet curable adhesive: KBM-5103=100 PHR:1 PHR) and a third one in which KBM-603 and KBM-5103 were added into the ultraviolet curable adhesive (the ultraviolet curable adhesive: KBM-603: KBM-5103=100 PHR:1 PHR:1 PHR) In this evaluation analysis, a sample and an alkali solution are taken into a 20 ml vial container for headspace and sealed, and then the vial container is heated with a headspace sampler. Next, methanol generated by this heating was quantitatively measured with GC. Table 4 indicates the amount of methanol as the ratio (%) of it to the GC area or the GC area at the time of blending.

TABLE 4

| | | KBM603 | | KBM5103 | | KBM603 + KBM5103 | |
|---|---|---|---|---|---|---|---|
| | | (1.0 PHR) | | (1.0 PHR) | | (1.0 + 1.0 PHR) | |
| Elapsed Time | | GC area | | GC area | | GC area | |
| After Blending | | of Methanol | Ratio % | of Methanol | Ratio % | of Methanol | Ratio % |
| 0 | hr | 498.5 | 100 | 515 | 100 | 785.4 | 100 |
| 4 | hr | 55.6 | 11.2 | 72.1 | 14.0 | 441.5 | 56.2 |
| 8 | hr | 29.3 | 5.9 | 22.2 | 4.3 | 414.7 | 52.8 |
| 12 | hr | 18.7 | 3.8 | 19.3 | 3.7 | 380.1 | 48.4 |
| 24 | hr | 18.5 | 3.7 | 12.0 | 2.3 | 329.5 | 42.0 |

As shown in FIG. 4, the residual amount of a methoxy group was remarkably reduced to be under 15% within four hours after blending in cases of the first one in which only KBM-603 was added into the ultraviolet curable adhesive (indicated as KBM-603 “1.0 PHR”), and the second one in which only KBM-5103 was added into the ultraviolet curable adhesive (indicated as KBM-5103 “10.0 PHR”.)

On the other hand, the residual amount of a methoxy group was still over 40% even after twenty four hours have elapsed after blending in the case of a third one in which KBM-603 and KBM-5103 were added into the ultraviolet curable adhesive (indicated as KBM-603+KBM-5103 “1.0 PHR+1.0 PHR”.)

The result support previous findings that the adhesive layer in which KBM-603 and KBM-5103 were blended as the ratio of 1:1 PHR showed excellent adhesiveness and humidity resistance in any environments, as shown in Table 3.

### INDUSTRIAL APPLICABILITY

The present invention can be applied to a field for manufacturing and/or using a cover member for push button switch.

1. (canceled)

2. (canceled)

3. (canceled)

4. A cover member for a push button switch comprising:
a resin key top;
a silicone rubber key sheet integrated with the resin key top; and
an adhesive layer that bonds the silicone rubber key sheet with the resin key top and includes an optical curing resin, an amine silane compound and a hydrophobic silane compound, wherein
the area of the adhesive layer is one third or more of the area in which the silicone rubber key sheet is bonded with the resin key top, and
the amine silane compound is 3-(2-aminoethyl)aminopropyltrimethoxysilane
and the acrylic silane compound is acryloyloxypropyltrimethoxysilane.

5. The cover member for a push button switch according to any of claim 1, wherein
the adhesive layer includes an adhesive layer in which at least two kinds of the silane compounds are added to the optical curing resin as 100 Per Hundred Resin(PHR) and the total amount of these silane compounds is greater or equal to 0.5 PHR and 7.0 PHR or less.

6. A method of manufacturing a cover member for a push button switch that includes a resin key top and a silicone rubber key sheet integrated with the resin key top, the method comprising:
heating an adhesive layer including an optical curing resin, 3-(2-aminoethyl)aminopropyltrimethoxysilane, and a acryloyloxypropyltrimethoxysilane to the range from 15 degrees C. or more to 30 degrees C. or less;
coating the adhesive layer onto at least one of the adhesive layer surfaces of the resin key top and the silicone rubber key sheet;
bonding the resin key top and the silicone rubber key sheet with the adhesive layer: and
curing the adhesive layer by irradiating a ultraviolet ray to the adhesive layer so that the area of the adhesive layer becomes one third or more of the adhesive layer areas of the resin key top and the silicone rubber key sheet.
